(19) United States
(12) Patent Application Publication
(10) Pub. No.: US 2007/0101009 A1
(43) Pub. Date: May 3, 2007

(54) Method and system for automatic/dynamic instant messaging location switch

(76) Inventors: Yen-Fu Chen, Austin, TX (US); John Hans Handy-Bosma, Cedar Park, TX (US); Keith Raymond Walker, Austin, TX (US); Sarah Vijoya White Eagle, Austin, TX (US)

Correspondence Address: IBM CORP (YA);C/O YEE & ASSOCIATES PC, P.O. BOX 802333, DALLAS, TX, 75380, US

(21) Appl. No.: 11/260,577

(22) Filed: Oct. 27, 2005

(51) Int. Cl. G06F 15/173; G06F 15/16

(52) U.S. Cl. 709/229; 709/225

(57) ABSTRACT

The present invention provides a method, system, and computer program product for improved functionality within an instant messaging system. A user's identification is authorized when the user logs on to a current device. A determination that the user is logged on to another, original, device is made. Applicable instant messaging user preferences from the original device are copied and applied to the current device.

### BACKGROUND OF THE INVENTION

1. Field of the Invention

The present invention relates generally to information processing systems, and more particularly, to a method and system for improved functionality within instant messaging systems.

2. Description of the Related Art

Modern computing technology has resulted in immensely complicated and ever-changing environments. One such environment is the Internet, which is also referred to as an “internetwork.” The Internet is a set of computer networks, possibly dissimilar, joined together by means of gateways that handle data transfer and the conversion of messages from a protocol of the sending network to a protocol used by the receiving network. When capitalized, the term “internet” refers to a collection of networks and gateways that use the TCP/IP suite of protocols. Currently, the most commonly employed method of transferring data over the Internet is to employ the World Wide Web environment, also called the “Web”.

The existence and continued acceptance and use of the Web and the Internet have resulted in many new and useful applications becoming available to users of the Internet. One useful and popular application that most everyone with access to the Internet uses is electronic mail (email). An email is a method of personal communication without requiring face to face contact. An email account allows a user to communicate a message to an intended email recipient. This is true even if the recipient has a different service provider than the sender. Email is based on a standard communication protocol that allows the communication of messages between individuals that may have different service providers. To correspond across the standard communications protocols using email, all that is required is the recipient's email address.

A recent advancement in the area of email and other forms of personal communication, such as web conferencing, etc., is an application, which is growing in popularity, known as “instant messaging.” Instant messaging systems are based on an architecture that usually includes at least one instant messaging server, multiple clients, and software that allows the multiple clients to communicate with each other and with the instant messaging server. A typical instant messaging exchange involves two or more users engaging in an online conversation, or chat, without the requirement of entering a message recipient's email address prior to each transmission. With instant messaging, a user sends an instant message to a recipient by typing a message on a keyboard and pressing a transmit or send button, or by simply hitting the enter key, or in the case of voice activated software, simply by speaking. In this streamlined manner, instant messaging users can chat by corresponding textually at a tempo approaching a conversational pace. Because instant messaging enables a contemporaneous textual exchange, it is now a preferred method of distance communication that has a myriad of potential uses.

While a typical instant messaging system is a single system such as AOL Instant Messenger, ICQ, Yahoo! Messenger, MSN chat, and Internet Relay Chat (IRC), some hybrid systems, such as Trillian, Fire, and Everybuddy, allow a user to send instant messages to people on various other systems from that single system, it should be understood that the present invention encompasses all of these types of systems.

Instant messaging has become an important part of both personal and business communications. At home, publicly available instant messaging clients can be used as a means of long distance communication between relatives and friends.

Instant messaging is a potentially valuable tool in the business world because decisions often must be made quickly. The popularity of instant messaging in the business place stems from the capability of a user to continuously detect the presence of others, and instantly collaborate with them online. Instant messaging also has the potential to be useful in call centers for businesses.

Various instant messaging applications are provided from many sources but all such applications have many common features. For example, these applications permit a user to chat with an individual person and, typically, there is also a feature allowing invitees to request that additional people join a chat. In general, instant messaging applications enable a user to register with an instant messaging server on the Web or other network using the Internet. Such applications may also be accessed through other local area and wide area networks as well. When a user accesses an instant messaging application, the user inputs the user's personal information together with a user identification (ID) and a password. The user is then enabled to designate a user name which will be used to identify the user in subsequent chat sessions or in sending messages to and receiving messages from other users. Instant messaging server clients can exchange text messages, audio, data and other types of multimedia files. Clients may also have a list of users called “buddy lists” that are known to them as friends, coworkers, or other user acquaintances.

As instant messaging is becoming a very valuable tool for both personal and business communications, with millions of users communicating using instant messaging systems every day, functionality and usability enhancements are important to the continued success of this communication tool. Current instant messaging applications do, however, have serious flaws and/or shortcomings which must be corrected if instant messaging is to continue to thrive as a communications vehicle.

### SUMMARY OF THE INVENTION

The present invention provides a method, system, and computer program product for improved functionality within an instant messaging system. A user's identification is authorized when the user logs on to a current device. A determination that the user is logged on to another, original, device is made. Applicable instant messaging user preferences from the original device are copied and applied to the current device.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which exemplary aspects of the present invention may be implemented;

FIG. 2 is a block diagram of a data processing system in which exemplary aspects of the present invention may be implemented;

FIG. 3 is a block diagram depicting typical software architecture for a server-client system in which exemplary aspects of the present invention may be implemented;

FIG. 4 is a flowchart illustrating the operation of presence detection in accordance with an exemplary embodiment of the current invention;

FIG. 5 is a flowchart illustrating the operation of the transfer process in accordance with an exemplary embodiment of the current invention;

FIG. 6 is a flowchart illustrating the operation of the message process in accordance with an exemplary embodiment of the current invention;

FIG. 7 is a flowchart illustrating the operation of sending an instant message to a device in accordance with an exemplary embodiment of the current invention; and

FIG. 8 is a block diagram depicting a system for automatic detection of a user's presence and locations switching in accordance with an exemplary embodiment of the present invention.

### DETAILED DESCRIPTION OF THE PREFERRED EMBODIMENT

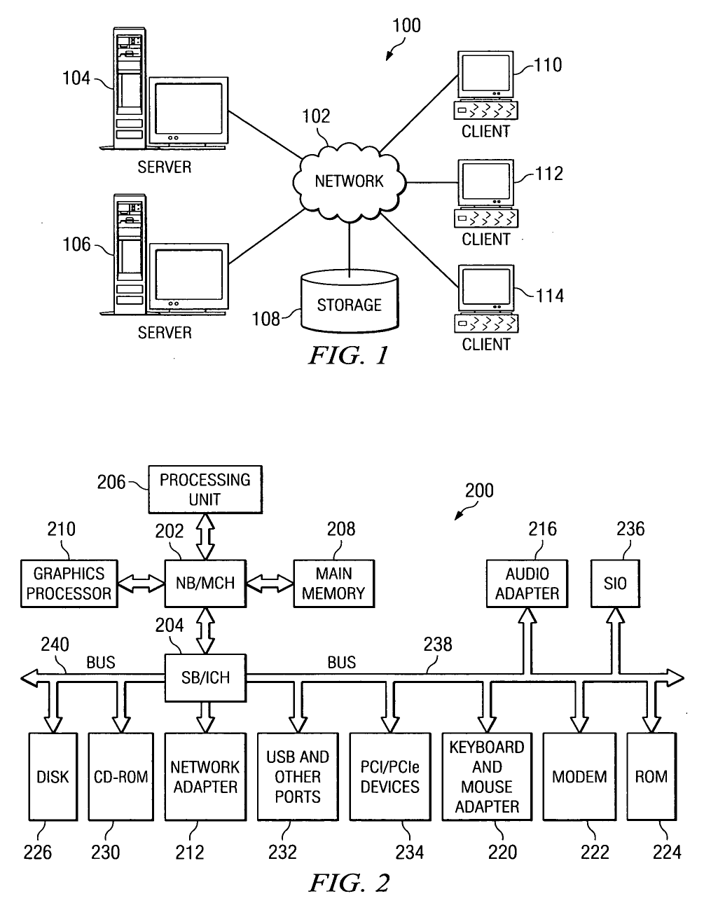

FIGS. 1-2 are provided as exemplary diagrams of data processing environments in which embodiments of the present invention may be implemented. It should be appreciated that FIGS. 1-2 are only exemplary and are not intended to assert or imply any limitation with regard to the environments in which aspects or embodiments of the present invention may be implemented. Many modifications to the depicted environments may be made without departing from the spirit and scope of the present invention.

With reference now to the figures, FIG. 1 depicts a pictorial representation of a network of data processing systems in which aspects of the present invention may be implemented. Network data processing system 100 is a network of computers in which embodiments of the present invention may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments of the present invention.

With reference now to FIG. 2, a block diagram of a data processing system is shown in which aspects of the present invention may be implemented. Data processing system 200 is an example of a computer, such as server 104 or client 110 in FIG. 1, in which computer usable code or instructions implementing the processes for embodiments of the present invention may be located.

In the depicted example, data processing system 200 employs a hub architecture including north bridge and memory controller hub (MCH) 202 and south bridge and input/output (I/O) controller hub (ICH) 204. Processing unit 206, main memory 208, and graphics processor 210 are connected to north bridge and memory controller hub 202. Graphics processor 210 may be connected to north bridge and memory controller hub 202 through an accelerated graphics port (AGP).

In the depicted example, LAN adapter 212 connects to south bridge and I/O controller hub 204. Audio adapter 216, keyboard and mouse adapter 220, modem 222, read only memory (ROM) 224, hard disk drive (HDD) 226, CD-ROM drive 230, universal serial bus (USB) ports and other communications ports 232, and PCI/PCIe devices 234 connect to south bridge and I/O controller hub 204 through bus 238 and bus 240. PCI/PCIe devices may include, for example, Ethernet adapters, add-in cards and PC cards for notebook computers. PCI uses a card bus controller, while PCIe does not. ROM 224 may be, for example, a flash binary input/output system (BIOS).

Hard disk drive 226 and CD-ROM drive 230 connect to south bridge and I/O controller hub 204 through bus 240. Hard disk drive 226 and CD-ROM drive 230 may use, for example, an integrated drive electronics (IDE) or serial advanced technology attachment (SATA) interface. Super I/O (SIO) device 236 may be connected to south bridge and I/O controller hub 204.

An operating system runs on processing unit 206 and coordinates and provides control of various components within data processing system 200 in FIG. 2. As a client, the operating system may be a commercially available operating system such as Microsoft® Windows® XP (Microsoft and Windows are trademarks of Microsoft Corporation in the United States, other countries, or both). An object-oriented programming system, such as the Java™ programming system, may run in conjunction with the operating system and provides calls to the operating system from Java programs or applications executing on data processing system 200 (Java is a trademark of Sun Microsystems, Inc. in the United States, other countries, or both).

As a server, data processing system 200 may be, for example, an IBM eServer™ pSeries® computer system, running the Advanced Interactive Executive (AIX®) operating system or LINUX operating system (eServer, pSeries and AIX are trademarks of International Business Machines Corporation in the United States, other countries, or both while Linux is a trademark of Linus Torvalds in the United States, other countries, or both). Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as hard disk drive 226, and may be loaded into main memory 208 for execution by processing unit 206. The processes for embodiments of the present invention are performed by processing unit 206 using computer usable program code, which may be located in a memory such as, for example, main memory 208, read only memory 224, or in one or more peripheral devices 226 and 230.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the present invention may be applied to a multiprocessor data processing system.

In some illustrative examples, data processing system 200 may be a personal digital assistant (PDA), which is configured with flash memory to provide non-volatile memory for storing operating system files and/or user-generated data.

A bus system may be comprised of one or more buses, such as bus 238 or bus 240 as shown in FIG. 2. Of course the bus system may be implemented using any type of communications fabric or architecture that provides for a transfer of data between different components or devices attached to the fabric or architecture. A communications unit may include one or more devices used to transmit and receive data, such as modem 222 or network adapter 212 of FIG. 2. A memory may be, for example, main memory 208, read only memory 224, or a cache such as found in north bridge and memory controller hub 202 in FIG. 2. The depicted examples in FIGS. 1-2 and above-described examples are not meant to imply architectural limitations. For example, data processing system 200 also may be a tablet computer, laptop computer, or telephone device in addition to taking the form of a PDA.

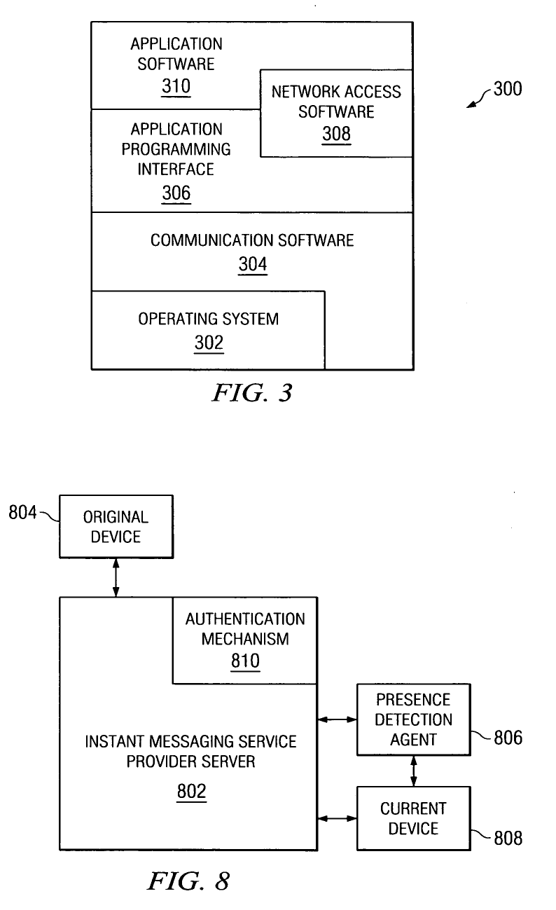

Turning to FIG. 3, typical software architecture for a server-client system is depicted in which exemplary aspects of the present invention may be implemented. At the lowest level, operating system 302 is utilized to provide high-level functionality to the user and to other software. Such an operating system typically includes a basic input/output system (BIOS). Communication software 304 provides communications through an external port to a network such as the Internet via a physical communications link by either directly invoking operating system functionality or indirectly bypassing the operating system to access the hardware for communications over the network.

Application programming interface (API) 306 allows the user of the system, an individual, or a software routine, to invoke system capabilities using a standard consistent interface without concern for how the particular functionality is implemented. Network access software 308 represents any software available for allowing the system to access a network. This access may be to a network, such as a local area network (LAN), wide area network (WAN), or the Internet. With the Internet, this software may include programs, such as Web browsers.

Application software 310 represents any number of software applications designed to react to data through the communications port to provide the desired functionality the user seeks, such as an instant messaging application. Applications at this level may include those necessary to handle data, video, graphics, photos or text, which can be accessed by users of the Internet.

Instant messaging relies on “presence technology” where users can see whether others are on-line. Both users (initiator and receiver) must subscribe to the same service and be on-line at the same time for instant messaging to provide real-time message communication. Advanced instant messaging offers permission setting so initiator and receiver must allow participation from one another and be willing to participate in accepting messages. An attempt to send an instant message to someone who is off-line or where presence is unavailable will result in notification that transmission cannot be completed, and, in some implementations, an off-line message that the receiver will see upon next login.

A user may own and use instant messaging on more than one device, and each device may have different operating system and software applications installed. For example, a user may instant message on a Windows® notebook computer at multiple locations, an AIX® server in a lab, a Linux® desktop computer in the office, and a PalmOS® PDA. For security, instant messaging providers only allow one login session at a time. Some handle initiation of multiple sessions by either denying the new session or disconnecting the old session. When a user initiates a session on another device, existing message conversations do not transfer to the current device. So context is lost, chat windows have to be re-created manually, and, sometimes the other user needs to copy and paste history of the conversation into the new chat window to make up for the lack of context. Instant messaging lacks the functionality of dynamic switch over to the “active” machine for user via automatic detection of user's presence.

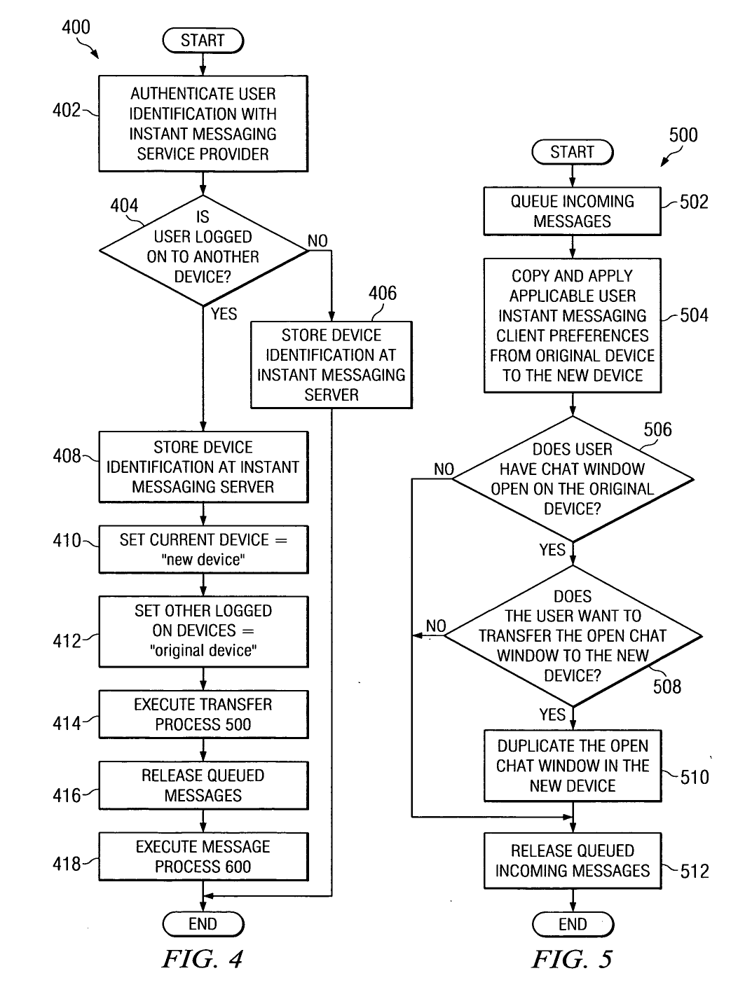

FIG. 4 is a flowchart illustrating the operation of presence detection, generally designated by reference number 400, in accordance with an exemplary embodiment of the current invention. The operation begins when a user authenticates the user's identification with an instant messaging provider server (step 402), which may be implemented as server 104 in FIG. 1. The operation determines if the user is currently logged in on another device (step 404). If the user is not logged in on another device (a no output to step 404), then device identification is stored at the instant messaging server (step 406) and the operation ends.

If the user is logged in on another device (a yes output to step 404), then device identification is stored at the instant messaging server (step 408). The current device is set as “new device” (step 410). Other logged on devices are set as “original device” (step 412). The operation executes transfer process 500 (step 414). The operation releases queued messages (step 416) and executes message process 600 (step 418). Then the operation ends. In another embodiment, the user may be currently logged onto more than one device, in which case “original device” refers to the entire set of currently active logged on devices.

It should be noted that while the above described exemplary embodiment is described in terms of logging on to a device through an instant messaging service provider server, those skilled in the art will realize that many other architectures are possible, such as using a proxy server or a peer-to-peer connection, and the above described implementation is not meant to limit the invention in any way.

FIG. 5 is a flowchart illustrating the operation of the transfer process, generally designated by reference number 500, in accordance with an exemplary embodiment of the current invention. Transfer process 500 implements step 414 in FIG. 4. The operation begins by queuing incoming messages at the server (step 502), which may be implemented as server 104 in FIG. 1. The operation copies and applies applicable user instant messaging client preferences from the original device to the new device (step 504). In an exemplary embodiment of the present invention, the user is prompted to choose whether to copy the user instant messaging client preferences from the original device to the new device. In another exemplary embodiment of the present invention, the user is prompted to choose for each individual user instant messaging client preference, whether to copy the user instant messaging client preferences from the original device to the new device.

In the case where the original device refers to multiple devices, the operation copies the user instant messaging client preferences from the most recently logged in device other than the new device, to the new device. In another exemplary embodiment of the present invention, the user is presented with a list of logged on devices and the user chooses which device to copy the user instant messaging client preferences from.

Some examples of client preferences include user settings such as alert preferences, window dimensions, contact lists and groups, and status messages. Some settings may not apply, such as those settings that are particular to a specific data processing system, like the install directory or video device.

The operation determines if the user has a chat message window open on the original device (step 506). If the user does not have a chat message window open on the original device (a no output to step 506), the operation releases queued incoming messages (step 512) and ends. If the user does have a chat message window open on the original device (a yes output to step 506), the operation determines if the user wants to transfer the open chat window to the new device (step 508).

Depending upon the particular implementation, the determination of whether the user wants to transfer the open chat window to the new device may be achieved either by prompting the user directly or through a user setting, as part of the user preferences, in the main instant messaging menu options.

If the user does not want to transfer the open chat window to the new device (a no output to step 508), the operation releases queued incoming messages (step 512) and ends. If the user does want to transfer the open chat window to the new device (a yes output to step 508), the operation duplicates the open chat window in the new device (step 510). The operation releases the queued incoming messages (step 512) and ends.

Duplicating the open chat window includes, but is not limited to, copying the window dimensions, contact chatting with, text history within the window, and the saved transcript history, if available, from the original device to the new device.

In an exemplary embodiment of the present invention, only text in the cache memory is transferred from the original device to the new device. In another exemplary embodiment of the present invention, the open chat message window information is transferred from the original device to the new device by file transfer. This implementation has the advantage of being able to include past conversation history as part of the information transferred. In an alternate exemplary embodiment of the present invention, the chat history is transferred in the background.

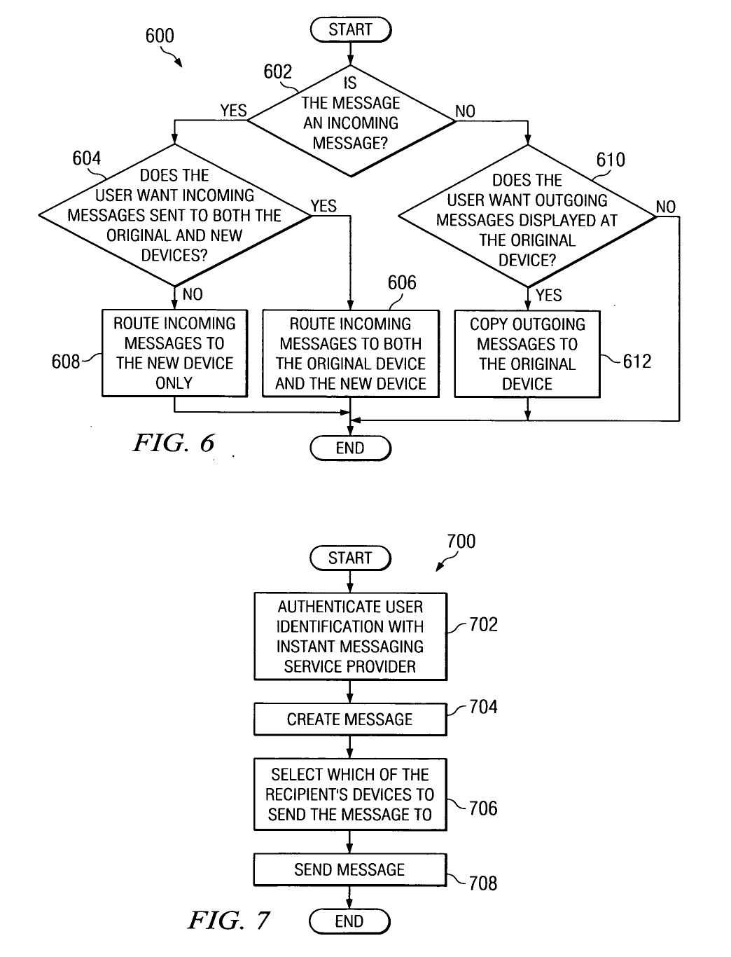

FIG. 6 is a flowchart illustrating the operation of the message process, generally designated by reference number 600, in accordance with an exemplary embodiment of the current invention. Message process 600 implements step 418 in FIG. 4. The operation begins by determining if the message is an incoming message (step 602). If the message is an incoming message (a yes output to step 602), the operation determines if the user wants incoming messages sent to both the original and the new device (step 604). In an exemplary embodiment of the present invention, instead of the user, the instant messaging service provider decides whether messages are sent to both the original and the new device.

In another exemplary embodiment of the present invention, the user may choose to have incoming messages from specific users sent to specific devices. For example, the user may choose to have all messages from a certain user or group of users sent to the original device only, incoming messages from another specific user or set users may be sent to the new device only, and all other messages are sent to both devices.

If the user does want incoming messages sent to both the original and the new device (a yes output to step 604), the operation routes chat messages to both the original and the new devices (step 606) and ends. If the user does not want incoming messages sent to both the original and the new device (a no output to step 604), the operation routes incoming messages to the new device only (step 608) and ends.

If the message is not an incoming message (a no output to step 602), the operation determines if the user wants the outgoing message displayed at the original device (step 610). If the user wants the outgoing message displayed at the original device (a yes output to step 610), the operation copies the outgoing message to the original device (step 612) and ends. If the user does not want the outgoing message displayed at the original device (a no output to step 610), the operation ends.

In another exemplary embodiment of the present invention, the user may choose to have outgoing messages to specific users sent to specific devices. For example, the user may choose to have all messages that are sent to a certain user or group of users copied to the original device, while all other outgoing messages that may be sent are not copied to the original device.

FIG. 7 is a flowchart illustrating the operation of sending an instant message to a device, generally designated by reference number 700, in accordance with an exemplary embodiment of the current invention. The operation begins when a user, the sender, authenticates the user's identification with an instant messaging provider server (step 702), which may be implemented as server 104 in FIG. 1. The sender then creates an instant message to send to a receiver (step 704). The sender chooses which of the recipient's devices to send the message to (step 706). The message is sent (step 708) and the process ends.

In an exemplary embodiment of the present invention, the instant messaging service provider maintains a list, at the service providing server, of all the devices that a particular user has ever logged in on. A sender may choose to send their instant message to the recipient at any of the devices contained in the list of devices that the recipient has logged in on, by selecting that particular device. In another exemplary embodiment of the present invention, instead of selecting a device from a list of recipient's known devices, the sender may designate any device known to the sender for receiving the message. The sender may designate the known device through use of, but not limited to, an internet protocol (ip) address or a media access control (mac) address, input at a prompt.

In an exemplary embodiment of the present invention a particular user can block a device from being selected for receipt of a message. The instant messaging service provider may provide an option to choose to not show a device on the particular user's device list. Alternately, an option may be provided to block choice of message delivery only from certain users. That is, some users are allowed to send messages to the device, so the device is visible on the list of recipient devices for those senders but blocked senders do not see the device as a choice on their recipient device list.

FIG. 8 is a block diagram depicting a system for automatic detection of a user's presence and locations switching in accordance with an exemplary embodiment of the present invention. Instant messaging service provider server 802, which may be implemented as server 104 in FIG. 1, acts as central gateway to manage all other devices. In the present example, only two other devices, current device 808 and original device 804, and one presence detection agent, presence detection agent 806, are shown. However, the system may be comprised of any number of devices and any number of detection agents.

Original device 804 is any device where a user can log onto and implement an instant messaging chat session. In an exemplary embodiment of the present invention, once the user has initially logged on to original device 804 and authenticated his/her user identification with instant messaging service provider server 802, the user does not need to log on again on other devices, as this process is handled automatically by instant messaging service provider server 802 through authentication mechanism 810. Authentication mechanism 810 authenticates the user's identification through local mechanisms, including, but not limited to, Lightweight Directory Access Protocol (LDAP), built-in authentication, authentication methods provided by runtime libraries, Secure Shell (SSH), or upon detection of network settings, functioning in a “trust mode” if the device is on the same subnet or approved IP address range. Traffic can be encrypted with certificates using Secure Socket Layer (SSL), Transport Layer Security (TSL), or other encryption protocols.

Presence detection agent 806 may be implemented as either hardware or software or a combination of both. Some examples of presence detection agents include, but are not limited to, the activation of certain programs, mouse movement, keyboard use, or more sophisticated systems such as a voice recognition system, a biometric system, or a motion detector system. Once presence detection agent 806 determines that the user is physically at current device 808, presence detection agent 806 sends the IP address or mac address of current device 808 to instant messaging service provider server 802. Authentication mechanism 810 authenticates the user's identification. Instant messaging service provider server 802 then prepares and enables current device 808 for instant messaging communication.

Thus, an exemplary embodiment of the present invention provides the functionality of dynamically switching over to the “active” machine for a user via automatic detection of user's presence.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for improved functionality within an instant messaging system, the computer implemented method:
authenticating a user identification;
logging the user on to a current device; and
responsive to a determination that the user is logged on to at least one original device, copying and applying applicable instant messaging user preferences from the original device to the current device.

2. The computer implemented method of claim 1, wherein an instant messaging service provider server performs the step of authenticating a user identification.

3. The computer implemented method of claim 1, further comprising:
storing a device identification.

4. The computer implemented method of claim 3, wherein an instant messaging service provider server stores the device identification.

5. The computer implemented method of claim 1, wherein copying and applying applicable instant messaging user preferences from the original device to the current device comprises:
responsive to the user choosing to copy the instant messaging user preferences from the original device to the new device, copying and applying applicable instant messaging user preferences from the original device to the current device.

6. The computer implemented method of claim 1, wherein the original device comprises a plurality of devices.

7. The computer implemented method of claim 6, wherein copying and applying the applicable instant messaging user preferences from the original device to the current device comprises:
copying the instant messaging user preferences from a most recently logged in device other than the current device, to the current device.

8. The computer implemented method of claim 6, wherein copying and applying the applicable instant messaging user preferences from the original device to the current device comprises:
prompting the user to select which device to copy the instant messaging user preferences from.

9. The computer implemented method of claim 1, further comprising:
determining if the user has a chat window open on the original device; and
responsive to a determination that the user wants to transfer the open chat window from the original device to the current device, duplicating the open chat window in the original device in the current device.

10. The computer implemented method of claim 9, wherein duplicating the open chat window in the original device in the current device comprises:
transferring the open chat window information from the original device to the current device by file transfer.

11. The computer implemented method of claim 10, wherein transferring the open chat window information from the original device to the current device by file transfer comprises:
transferring a chat history in the background.

12. The computer implemented method of claim 9, further comprising:
responsive to a determination that the user wants an outgoing message copied to the original device, copying the outgoing message to the original device.

13. The computer implemented method of claim 9, further comprising:
responsive to a determination that the user wants an incoming message sent to the original device, sending the incoming message to the original device.

14. The computer implemented method of claim 13, wherein the incoming message is an incoming message from a specific user.

15. The computer implemented method of claim 13, wherein the incoming message is an incoming message from a specific plurality of users.

16. The computer implemented method of claim 9, further comprising:
responsive to a determination that the user wants an incoming message sent to the original device and the current device, sending the incoming message to the original device and the current device.

17. A computer program product comprising
a computer usable medium including computer usable program code for improved functionality within an instant messaging system, said computer program product including;
computer usable program code for authenticating a user identification;
computer usable program code for logging the user on to a current device; and
computer usable program code, responsive to a determination that the user is logged on to at least one original device, for copying and applying applicable instant messaging user preferences from the original device to the current device.

18. A computer implemented method for improved functionality within an instant messaging system, the computer implemented method:
authenticating a user identification;
logging the user on to a current device;
creating a message;
selecting a device from a plurality of devices to form a selected device, wherein the user selects the device; and
sending the message to the selected device.

19. The computer implemented method of claim 18, wherein the plurality of devices comprises all devices that a particular user has logged in on.

20. The computer implemented method of claim 18, wherein an instant messaging service provider server stores a list of the plurality of devices.
